(19) United States
(12) Patent Application Publication
(10) Pub. No.: US 2019/0180290 A1
(43) Pub. Date: Jun. 13, 2019

(54) PROCUREMENT FRAUD DETECTION SYSTEM

(71) Applicant: Accenture Global Solutions Limited, Dublin (IE)

(72) Inventors: Laura Alvarez Jubete, Dublin (IE); Ali Hosseinzadeh Vahid, Dublin (IE); Shashi Bhushan Tyamagondlu Nagabhushan, Dublin (IE); Sidath Handurukande, Dublin (IE); Medb Corcoran, Dublin (IE)

(21) Appl. No.: 15/835,732

(22) Filed: Dec. 8, 2017

(51) Int. Cl. G06Q 30/00; G06Q 20/40; G06F 17/30; G06Q 50/00; G06F 9/44; G06N 3/08; G06N 5/02; G06F 15/18

(52) U.S. Cl. CPC G06Q 30/0185; G06Q 20/4016; G06F 17/30539; G06F 15/18; G06F 9/4443; G06N 3/088; G06N 5/025; G06Q 50/01

(57) ABSTRACT

This document describes systems, methods, devices, and other techniques for detecting procurement fraud in one or more procurement processes. In some implementations, a computing device receives input data representing one or more procurement processes, processes the received input data to generate a respective risk score for each procurement process, each risk score representing a likelihood that the respective procurement process is fraudulent, comprising processing the received input data using (i) one or more predetermined rules and scenarios, and (ii) atypical patterns data mined through unsupervised learning mechanisms, and provides, based on the generated risk score, output data indicating procurement processes that are likely to be fraudulent.

### TECHNICAL FIELD

This specification generally describes methods and systems for detecting procurement fraud.

### BACKGROUND

Procurement is the process of finding, agreeing terms and acquiring goods or services from an external source. A typical procurement process, from an internal buyer's perspective, can include the stages of purchasing, whereby goods are ordered from a vendor, receiving, whereby a shipment of goods is received from a vendor, and payments, whereby the vendor is paid for the goods. The same procurement process from the external vendor's perspective includes the stages of order management, whereby an order is received from the buyer, shipping, whereby goods are delivered to the buyer, and payment, whereby the vendor receives payment from the buyer for the delivered goods.

Identifying instances of procurement fraud in a procurement process is challenging. Firstly, due to the nature of fraud and collusion, instances can be subtle or well hidden. Secondly, organizations and procurement processes within organizations generate and maintain large amounts of varying types of data. Analyzing large amounts of varying types of data to reliably identify candidate cases of procurement fraud is a complex and difficult task. To reduce the complexity of the task, organizations typically implement static rules and policies to filter the amount of data for analysis. For example, an organization may have a policy that states that any transactions between a buyer and vendor that exceed a predetermined threshold, e.g., 10,000USD, should be analyzed and/or approved by a senior organization employee.

### SUMMARY

Innovative aspects of the subject matter described in this specification may be embodied in methods for detecting procurement fraud in one or more procurement processes, the methods including the actions of receiving input data representing one or more procurement processes; processing the received input data to generate a respective risk score for each procurement process, each risk score representing a likelihood that the respective procurement process is fraudulent, comprising processing the received input data using (i) one or more predetermined rules and scenarios, and (ii) atypical patterns data mined through unsupervised learning mechanisms; and providing, based on the generated risk score, output data indicating procurement processes that are likely to be fraudulent.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus (e.g., one or more computers or computer processors), cause the apparatus to perform the actions.

The foregoing and other embodiments can each optionally include one or more of the following features, alone or in combination. In some implementations atypical patterns comprise (i) atypically high payments, (ii) atypical purchase patterns, (iii) numerous atypical associations in purchases, (iv) repeated procurement process by-pass, or (v) network patterns of various indications of fraudulent activity.

In some implementations processing the received input data to generate a respective risk score for each procurement process using atypical patterns data mined through unsupervised learning mechanisms comprises: accessing historical input data; data mining the historical input data using anomaly detection techniques to identify atypical patterns in the historical input data; comparing properties of the received input data to properties of the identified atypical patterns in the historical input data to determine respective measures of similarity between the one or more procurement processes and the identified atypical patterns; and generating a respective risk score for each procurement process based on the determined measure of similarity.

In some implementations the predetermined rules and scenarios comprise (i) static rule based scenarios, (ii) paired rule based scenarios, (iii) statistical rule based scenarios, or (iv) network analysis based scenarios.

In some implementations processing the received input data to generate a respective risk score for each procurement process using one or more predetermined rules and scenarios comprises: evaluating the predetermined rules and scenarios to determine whether one or more of the predetermine rules and scenarios are satisfied or not; and generating a respective risk score for each procurement process based on whether the rules and scenarios are satisfied or not.

In some implementations the received input data representing multiple procurement processes comprises procurement data for each procurement process, wherein procurement data comprises data representing (i) invoice line items, (ii) goods receipts, (iii) purchase order data, (iv) human resources data, or (v) vendor data associated with a procurement process in the organization.

In some implementations the received input data representing multiple procurement processes further comprises employee data for employees involved in the multiple procurement processes, wherein employee data comprises human resources data and data from external sources such as social media networks or professional networks.

In some implementations the received input data representing multiple procurement processes further comprises audit data.

In some implementations providing output data indicating procurement processes that are likely to be fraudulent comprises providing k top scoring invoice line items.

In some implementations providing output data indicating procurement processes that are likely to be fraudulent comprises providing invoice line items whose respective risk scores exceed a predetermined threshold.

In some implementations the method further comprises receiving feedback data confirming whether the procurement processes that are likely to be fraudulent are fraudulent or not.

In some implementations the method further comprises performing supervised learning using the received feedback data to update the one or more predetermined rules and scenarios.

In some implementations providing output data indicating procurement processes that are likely to be fraudulent comprises providing a user interface as output, the user interface presenting an aggregated view of information relating to the procurement processes that are likely to be fraudulent, and wherein feedback data is received through the user interface.

In some implementations the user interface presents a stratified representation of information relating to the procurement processes that are likely to be fraudulent.

In some implementations the user interface presents a linked data representation of information relating to the procurement processes that are likely to be fraudulent.

Some implementations of the subject matter described herein may realize, in certain instances, one or more of the following advantages. A system implementing procurement fraud detection, as described in this specification, detects instances of fraudulent activity within a procurement process. By combining multiple methods of detection, such as application of specific types of rules and atypical patterns mined using unsupervised learning techniques, the system can more efficiently and effectively detect cases of procurement fraud.

In addition, a system implementing procurement fraud detection, as described in this specification, can be tailored to a particular organization and therefore achieve higher levels of accuracy when detecting procurement fraud. For example, the system can use historical data from within the organization to generate rules and scenarios that can be applied to detect cases of fraudulent activity.

In addition, a system implementing procurement fraud detection, as described in this specification, implements a feedback mechanism that enables the system to learn and become more intelligent over time, thus increasing the effectiveness of the system over time. This can be particularly advantageous since fraud tactics are constantly evolving, with fraudsters constantly working to outsmart or get around fraud detection systems. However, the system described in this specification learns and evolves new fraud patterns and tactics over time, and is therefore better able to thwart fraudster and fraudulent activity.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 illustrates an example procurement process.

FIG. 2 is a block diagram of an example procurement fraud detection system.

FIG. 3 is a flow chart of an example process for detecting procurement fraud.

FIG. 4 is a flow chart of an example process for generating risk scores for procurement processes using atypical patterns data mined through unsupervised learning mechanisms.

FIG. 5 is a flow chart of an example process for generating risk scores for procurement processes using one or more predetermined rules and scenarios.

FIG. 6 illustrates a schematic diagram of an exemplary generic computer system.

Like reference symbols in the various drawings indicate like elements.

### DETAILED DESCRIPTION

This specification describes a computer-based system for detecting cases of procurement fraud within an organization. The system receives data inputs related to procurement processes occurring within the organization. The system processes the received data inputs by evaluating one or more rules. The rules may include business or domain rules or policies defined by experts within the organization. In addition, the rules may include rules generated by the system using unsupervised learning. For example, the system may mine data representing historical procurement processes and identify abnormal patterns in the data and patterns that leads to undesirable scenarios, e.g., abnormally high payments, abnormal purchase patterns, numerous abnormal associations in purchases, repeated procurement process by-pass, or network patterns of various indications of fraudulent activity.

The system generates scored data inputs using outputs of evaluated rules or patterns, with a score indicating a likelihood that the respective procurement process is fraudulent. A procurement process is considered to be fraudulent if it includes fraudulent activity, e.g., if procurement fraud is being committed during one or more stages of the procurement process. The system ranks the scored data inputs and provides as output a set of filtered data inputs. For example, the set of filtered data inputs may include data representing k top scoring invoice line items for a particular procurement process. As another example, the set of filtered data inputs may include data representing a number of invoice line items with scores that exceed a predetermined threshold. The output filtered data inputs therefore represent likely fraudulent procurement processes.

In some cases the system may generate a user interface that shows a user-friendly aggregated view of information relating to the use the set of filtered data inputs. Alternatively or in addition the system can use the set of filtered data inputs as part of a supervised learning process. For example, the set of filtered data inputs may be labelled as being accurately classified as likely fraudulent or inaccurately classified as likely fraudulent. The labelled filtered data inputs can then be used to train or fine tune a classifier included in the system.

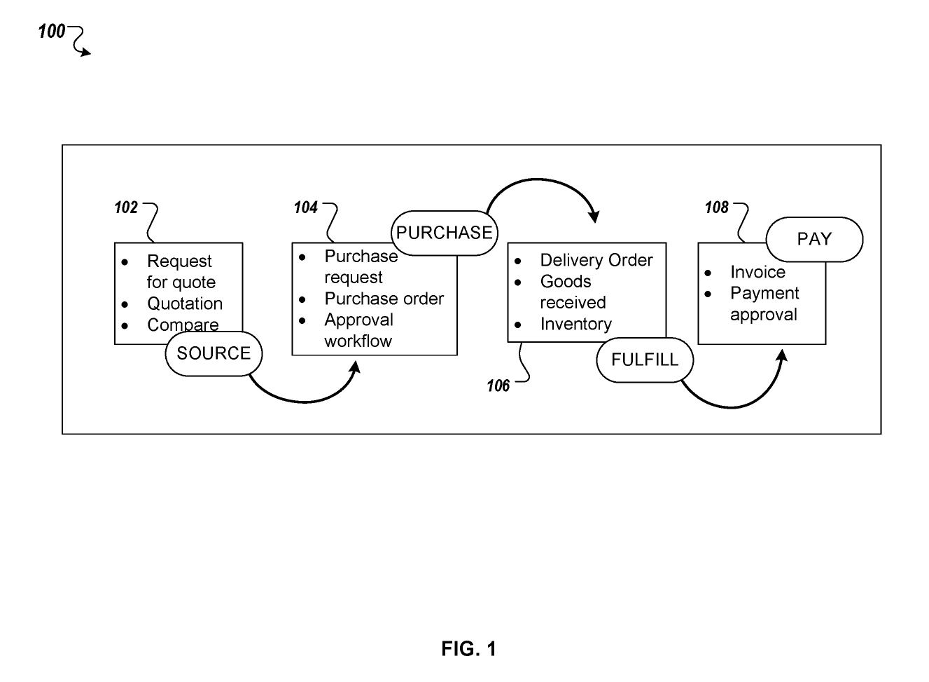

FIG. 1 is an illustration 100 of an example procurement process from a buyer's perspective. The first stage 102 of the example procurement process includes sourcing. A buyer sources goods or services by requesting quotations from various vendors. The buyer receives quotations from the various vendors and compares the quotations to select an appropriate vendor.

The second stage 104 of the example procurement process includes purchasing. The buyer submits a request to the selected vendor for the required goods or services. The buyer orders the goods or services from the vendor. The request and order of the goods and services will typically be approved by an appropriate member of within the buyer's organization.

The third stage 106 of the example procurement process includes fulfillment. Goods or services are received from the vendor, The buyer may perform an inventory to check that the received goods or services match the requested goods or services.

The fourth stage 108 of the example procurement process includes payment. The buyer receives an invoice from the vendor, requests approval to pay the amount stated in the invoice from an appropriate member of the organization, and pays the vendor for the goods or services.

Procurement fraud can occur at any stage in the procurement process. For example, procurement fraud may occur internally within an organization. Examples of internal procurement fraud include situations where employees of an organization establish a dummy company or dummy supplier account within the organization's systems and seek to steal from the organization via fraudulent contracts, invoices or payments. In addition, procurement fraud may occur externally. Examples of external procurement fraud include situations where vendors deliver a lesser quantity of goods compared to what was ordered and paid for, or deliver a poorer quality of goods compared to what was ordered and paid for. In some cases, procurement fraud may include collusion whereby an employee or multiple employees conspire with an external vendor to defraud the organization. Examples of collusion include approving invoices for goods that were not delivered or approving invoices that are above contractual or market prices.

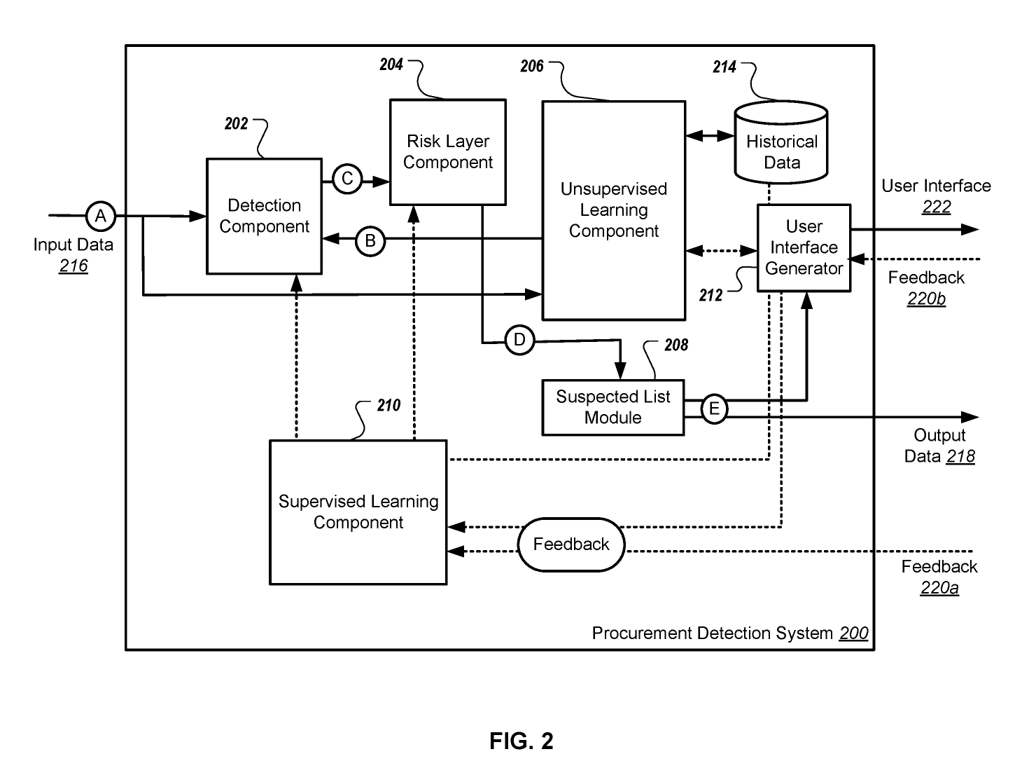

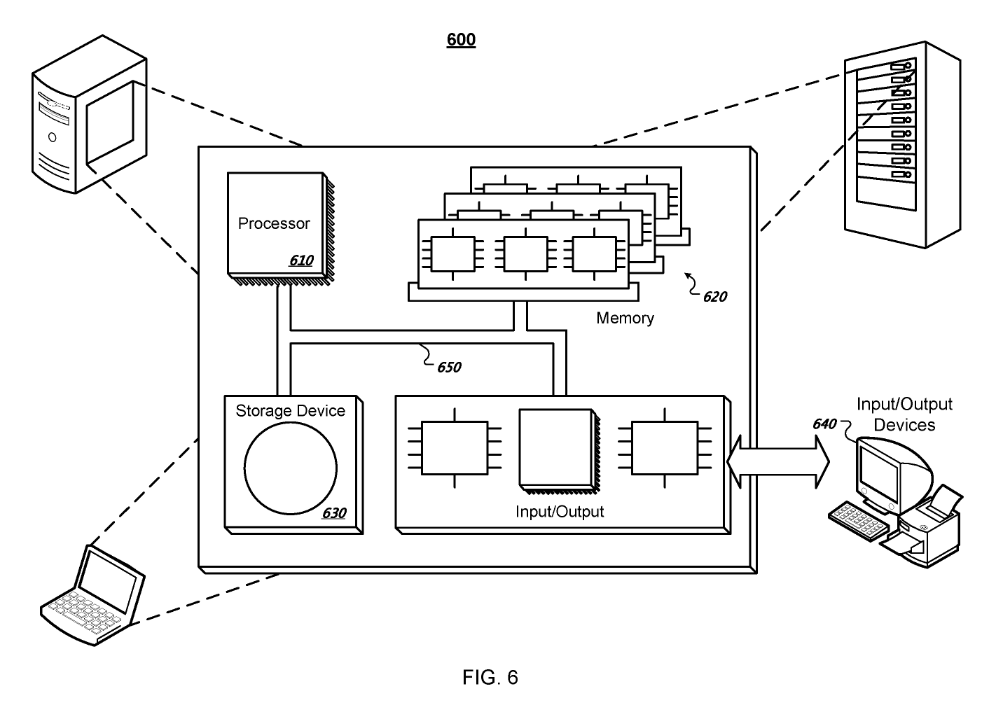

FIG. 2 depicts a conceptual block diagram of an example procurement fraud detection system 200. The block diagram shows the example procurement fraud detection system 200 performing a procurement fraud detection process (stages (A)-(E)). The system 200 can be enabled to receive input data that represents one or more procurement processes, e.g., input data 216. The input data can be processed by the system 200 to detect candidate cases of procurement fraud within the procurement processes and to generate output data representing procurement processes that are likely to be fraudulent, e.g., output data 218. Generally, the system 200 can be implemented as a system of one or more computers having physical hardware like that described with respect to FIG. 6.

Briefly, the system 200 includes a detection component 202, a risk layer component 204, an unsupervised learning component 206, a suspected list module 208, a supervised learning component 210, a user interface generator 212, and a historical input data database 214. The components of the system 200 can exchange electronic communications over one or more networks, or can exchange communications in another way, such as over one or more wired or wireless connections.

The detection component 202 is configured to receive input data that represents one or more procurement processes and to use the received input data to evaluate predetermined rules and scenarios, e.g., business rules and domain rules. For example, the detection component 202 may include a rule based system. The rule based system may include or be in data communication with one or more of the following components: a list of predetermined rules or rule base, an inference engine or semantic reasoning that infers information based on interactions between received input data and the rule base, a temporary working memory, and/or a user interface, e.g., user interface 220 provided by user interface generator 212.

The detection component 202 is further configured to receive and evaluate data representing rules and atypical patterns determined through unsupervised learning, e.g., data representing rules and patterns received from the unsupervised learning component 206. For example, the detection component 202 may be configured to analyze received data representing atypical patterns to determine properties of the atypical patterns and to analyze received input data representing multiple procurement processes to determine properties of the procurement processes. The detection component 202 may then compare the determined properties to determine whether the received input data exhibits any atypical patterns. In some implementations the atypical patterns may have been identified and converted into rules using the unsupervised learning component 206, then applied in the detection component 202. In some cases a significant amount of data may be required to generate such atypical patterns, e.g., historical data spanning a period of x (circa 12) months plus a current batch of input data being analyzed.

In some implementations the detection component 202 may be configured to receive feedback data, e.g., feedback data 220a. The received feedback data 220a may include data indicating whether a previously generated system output accurately detected a case procurement fraud or not. The detection component 202 may use received feedback data 220a to update or adjust the predetermined list of rules.

Feedback data may also be used by the supervised learning component to extract new directly applicable rules. For example, the supervised learning component may have access to data representing reasons behind certain predictions. Reasons can be used to extract new applicable rules. In addition, the supervised learning component may comprise an association-rule-mining component which may lead directly to the generation of new rules.

The detection component 202 is configured to provide as output data representing Boolean flags, e.g., a vector of flags where each vector element represents a particular machine learning generated rule or business rule evaluation result.

The risk layer component 204 is configured to receive as input data representing Boolean flags and to assign risk scores to the procurement process represented by the received system input data 216. For example, the risk layer component 204 may assign risk scores to invoice line items associated with the multiple procurement processes.

The risk layer component 204 is configured to provide as output data representing scored procurement processes. For example, the risk layer component 204 may provide as output data that identifies a procurement process and a corresponding overall risk score associated with the identified procurement process, the overall risk score indicating an overall likelihood, e.g., percentage, that the procurement process includes fraudulent activity. In other examples the risk layer component 204 may provide more detailed output data. For example, the risk layer component 204 may provide data that associates different types of input data with respective risk scores, e.g., data that associates each invoice line item with a respective risk score or data that associates each employee involved in the procurement process with a respective risk score. In some implementations the risk layer component 204 may further provide as output data indicating reasons why an item of input data has been assigned a respective risk score. For example, the risk layer component 204 may provide output data indicating that an invoice line item corresponding to a purchase of a particular item has been assigned a high risk score of 9/10 because the purchase exceeds a typical amount for the particular item per unit.

The suspected list module 208 is configured to store scored input data and generate system output representing procurement processes that are likely to be fraudulent, e.g., output data 218. For example, the suspected list module 208 may be configured to filter scored input data and generate output data representing the k-top scoring procurement processes or k-top scoring items of procurement data, e.g., k top scoring invoice line items. As another example, the suspected list module 208 may be configured to filter scored input data and generate output data representing procurement processes whose respective risk scores exceed a predetermined threshold or items of procurement data whose respective risk scores exceed respective predetermined thresholds, e.g., invoice line items whose risk scores exceed respective predetermined thresholds.

The user interface generator 212 is configured to generate user interfaces, e.g., user interface 222, that display processed system input data. For example, the user interface generator 212 may receive data from the suspected list module 208 or the unsupervised learning component 206 and load the received data into an interactive dashboard. The interactive dashboard may generate a user friendly display of the loaded data that may be analyzed by users, e.g., fraud investigators.

User interfaces generated by the user interface generator 212 may include various representations of system output data. For example, a generated user interface may include, for each procurement process, one or more of (i) vendor information such as name, contact information, length of partnership with the organization, (ii) invoice information such as an image of an invoice for the procurement process and important data relating to the invoice such as invoice number, requestor, approver, date of receipt, date of approval, date of payment, (iii) predetermined rules or scenarios applied to the procurement process, together with outputs of evaluating said predetermine rules or scenarios, a list of likely fraudulent activities in the procurement process together with associated risk scores indicating how likely it is that the activities are fraudulent, (iv) an overall risk score for the procurement process, or (v) a stratified representation of system output data. A stratified representation of system output data may include a graphical representation of procurement fraud investigations.

For example, procurement fraud investigations typically consider internal fraud, external fraud and collusion fraud. In each case, a fraud investigation may be centered around one or more employees, a vendor or both at the same time. These investigations may branch out to different cases via themes such as amounts, dates, patterns of invoices etc. As described above, the outcome of the risk scoring layer 204 may include a list of suspected instances of procurement fraud. This list may be sorted based on overall risk and cases of procurement fraud may be investigated one by one according to the list. Therefore, a need to look at a batch of invoices beyond the form of a list in a stratified way may arise. For example, the stratified representation of system output data may include identified communities/groups amongst multiple invoices that can be investigated together.

In some implementations a generated user interface may include a linked data representation of system output data. For example, the user interface generator 212 may perform data linking on the input data and processed input data using W3C recommended R2RML mappings from relational databases of systems to RDF datasets. Such mappings provide the ability to view existing relational data in the RDF data model, expressed in a structure and target vocabulary of the mapping. R2RML mappings are themselves expressed as RDF graphs and written down in Turtle syntax. Then, these RDF datasets with The W3C Web Ontology Language (OWL), which is a Semantic Web language designed to represent rich and complex knowledge about things, groups of things, and relations between things. OWL, a computational logic-based language is used to verify the consistency of that knowledge or to make implicit knowledge explicit.

The user interface generator 212 may further apply ontology reasoning to improve awareness and control of users over the usage of their information. Two example categories of reasoning tasks include 1) Ontology reasoning using description logic, which will use a restricted set of first order formulas for specifying a terminological hierarchy and 2) User-defined reasoning, which will infer a wide range of higher-level, conceptual context from relevant low-level context. Data linking is part of the data pre-processing. Presenting procurement data in this way allows a user of the system to perform richer query and execute powerful analytical data mining to discover facts by interlinking long chains of evidence; such techniques helps to find facts that generally goes undetected when using traditional data representations.

The historical data database 214 stores historical input data representing multiple procurement processes, e.g., input data previously received by the system 200. For example, the historical data database 214 may store data representing (i) invoice line items, (ii) goods receipts, (iii) purchase order data, (iv) human resources data, or (v) vendor data associated with historical procurement processes. The historical data database 214 may further store current or historical employee data, e.g., data representing information about one or more employees involved in the procurement processes such as human resource data or data extracted from social or professional networks. The historical database 214 may further store current or historical audit data, e.g., data extracted from audit tools that audit purchases within procurement processes.

The unsupervised learning component 206 is configured to process, e.g., data mine, data stored in the historical database 214 and identify patterns in the stored data. Identified patterns may include patterns atypical or anomalous patterns, or patterns that lead to atypical or anomalous scenarios. For example, the unsupervised learning component 206 may apply unsupervised anomaly detection (also known as outlier detection) techniques to detect anomalies in an unlabeled data set under the assumption that the majority of instances in the data are normal and therefore identifying instances in the data asset that seem to fit (or differ from) the remainder of the data. That is, the unsupervised learning component 206 may apply anomaly detection techniques to identify items, events or observations in the mined data that do not conform to an expected pattern or to other items in the mined data. Example techniques include but are not limited to density based techniques such as k-nearest neighbor or local outlier factors, cluster analysis based outlier detection, identification of deviations from association rules and frequent item sets, fuzzy logic based outlier detection, ensemble techniques, replicator neural networks or subspace and correlation based outlier detection techniques.

Example identified atypical patterns in the stored data include atypically high payments, atypical purchase patterns, multiple atypical associations in purchases, repeated procurement process by pass, or network patterns of indications of fraudulent activity. The unsupervised learning component 206 is configured to provide data representing identified atypical patterns in data stored in the historical data database 214 to the detection component 202.

The supervised learning component 210 is configured to receive data representing feedback to generated system output data, e.g., feedback data 220a or 220b. For example, the system may provide as output data representing procurement processes that are likely to be fraudulent, e.g., output data 218 or via a displayed user interface 222, and receive user feedback indicating whether the provided output data correctly or incorrectly detected a procurement process as including fraudulent activity. The supervised learning component 210 is configured to process received feedback data and generate one or more updates to the rules and scenarios applied by the detection component 202.

For example, the supervised learning component 210 may include a machine learning system that applies machine learning techniques using contextual knowledge captured by the system, e.g., feedback data to (1) predict whether if a procurement process may be fraudulent with an associated probability and/or (2) generate new rules or adjust existing rules and scenarios. Example machine learning techniques include association rule-learning, application of learning classifier systems or application of artificial intelligence systems. Outputs of the supervised learning component 210 can also be employed to adjust the weights of the rules in the risk layer component 204.

As described above, the system 200 may perform a procurement fraud detection process. For example, during stage (A) of an example procurement fraud detection process, the procurement fraud detection system 200 receives input data 216. The received input data 216 includes data representing one or more procurement processes. For example, the received input data 216 may include procurement data including data representing one or more of (i) goods receipts, (ii) invoice line items, (iii) purchase order data, (iv) human resources data, or (v) vendor data associated with a procurement process in the organization. In some implementations the input data 216 may include historical data that may be processed by the system 200 for training purposes. In some implementations the input data 216 may include new procurement data that is processed by the system to detect possible fraudulent activity in the new data. In some implementations the input data 216 may include a combination of historical data and new data. The system 200 transmits the received input data 216 to the detection component 202 and the unsupervised learning component 206.

During stage (B) of the example procurement fraud detection process, the unsupervised learning component 206 transmits data representing one or more atypical patterns data mined using unsupervised learning mechanisms using data stored in the historical data database 214 to the detection component 202.

The detection component 202 receives the input data 216 and the data representing one or more atypical data patterns. The detection component 202 processes the received input data 216 using one or more predetermined rules and scenarios and the data representing the atypical data patterns. For example, the detection component 202 may use the received input data 216 to evaluate one or more of the predetermine rules and scenarios. Furthermore, the detection component 202 may compare the received input data 216 to the data representing one or more atypical data patterns to determine whether the input data 216 exhibits similar atypical patterns.

During stage (C) of the example procurement fraud detection process, the detection component 202 transmits data representing results of evaluating the one or more predetermined rules and scenarios and of comparing the received input data to data mined atypical patterns to the risk layer component 204.

The risk layer component 204 receives the data transmitted from the detection component 202 and processes the received data to generate one or more respective risk scores for the procurement process. For example, the risk layer component 204 may use the received data to generate an overall risk score for the procurement process, or to generate respective risk scores for each item of input data, e.g., each invoice line item of an invoice associated with the procurement process. In some implementations the risk layer component 204 may further generate data indicating a reason for why a particular data item was assigned a respective risk score. The risk layer component 204 transmits scored input data, optionally including data representing reasons indicating why data items have been assigned respective risk scores, to the suspected list module 208.

The suspected list module 208 receives the data transmitted from the risk layer component 204 and processes the received data to generate output data representing procurement processes that are likely to be fraudulent. During stage (E) of the example procurement fraud detection process the suspected list module 208 provides the generate output data as system output or to the user interface generator 212 for further processing. Generated output data may be reviewed by one or more prevention investigators, detection investigators or fraud management. Appropriate action may then be taken.

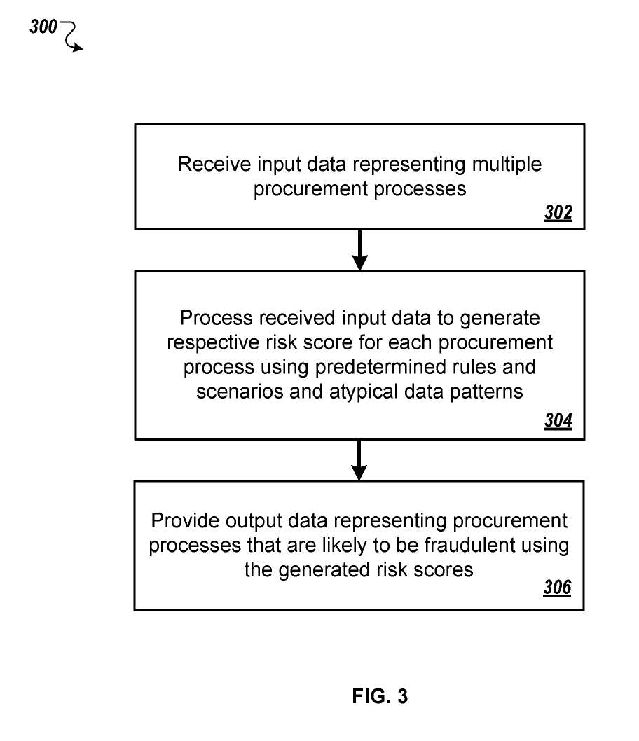

FIG. 3 is a flow chart of an example process 300 for detecting procurement fraud in one or more procurement processes. For convenience, the process 300 will be described as being performed by a system of one or more computers located in one or more locations. For example, a procurement fraud detection system, e.g., the system 200 of FIG. 2, appropriately programmed, can perform the process. Although the flowchart depicts the various stages of the process 300 occurring in a particular order, certain stages may in some implementations be performed in parallel or in a different order than what is depicted in the example process 300 of FIG. 3.

The system receives input data representing multiple procurement processes (step 302). The received input data includes procurement data for each procurement process. For example, the procurement data may include data representing invoice line items, e.g., data that names or describes goods sold or purchased in a particular procurement process, the cost of said goods per unit or hourly rate, the number of units bought or hours billed, and the total due for the goods sold or purchased.

The procurement data may further include data representing goods receipts, e.g., data representing documents issued to acknowledge the receipt of listed items in a procurement process.

The procurement data may further include purchase order data, e.g., data representing documents sent from a buyer to a supplier in a procurement process with a request for an order.

The procurement data may further include vendor data, e.g., data representing properties of a vendor involved in a procurement process such as vendor name, address, contact information and point of contact for the procurement process.

In some implementations the received input data representing multiple procurement processes comprises human resource/employee data for employees involved in the multiple procurement processes. Employee data may include data representing information about one or more employees involved in the procurement processes. For example, the employee data may include names of employees who are involved in a procurement process, length of service to the organization in which the procurement processes are taking place, or current position in the organization. In some implementations the employee data may further include data from external sources such as social media networks or professional networks. For example, the employee data may include data representing a network of professional contacts or social contacts for one or more employees involved in the procurement processes.

In some implementations the received input data representing multiple procurement processes comprises audit data. Audit data may include completed assessments for procurement processes performed by an audit team member to represent whether the procurement processes may be considered fraudulent or non-fraudulent. In addition, audit data may include a justification/explanation as to why the procurement processes have been deemed fraudulent or non-fraudulent.

The system processes the received input data to generate a respective risk score for each procurement process using one or more predetermined rules and scenarios and atypical patterns data mined through unsupervised learning mechanisms (step 304). For example, the risk scores may be generated using a risk score algorithm that assigns each rule and scenario a severity score, e.g., from 1 to 10, that has been collected from domain experts. The overall risk score asined to each procurement process may then be a function of “rule severity”, “scenario severity”, and “scenario weight factor”, e.g., if a rule severity has a score of 8/10 and a scenario severity has a score of 4/10 the system may assign the procurement process a risk score that is a combination of 8/10 and 4/10 (e.g., a weighted combination where the weights are system design parameters). In other examples a risk score may be equal to a maximum severity score of one rule or scenario, e.g., if a rule severity has a score of 8/10 and a scenario severity has a score of 4/10 the system may assign the procurement process a risk score of 8/10.

The risk score represents a likelihood that the procurement process is fraudulent. For example, a first procurement process that has a higher risk score than a second procurement process may be considered more likely to be fraudulent than the second procurement process. In some implementations the system may generate a respective set of risk scores for each procurement process using the one or more predetermined rules and scenarios and atypical patterns. For example, each risk score in a respective set of risk scores may correspond to an invoice line item and represent a likelihood that the invoice line item indicates fraudulent behavior.

The predetermined rules and scenarios used by the system to generate risk scores for procurement processes include business rules and domain rules. Domain rules are rules that can be derived from business strategies, requirements, technical guidelines and restrictions. Business rules are rules that are unrelated to information technology and can be derived from the domain.

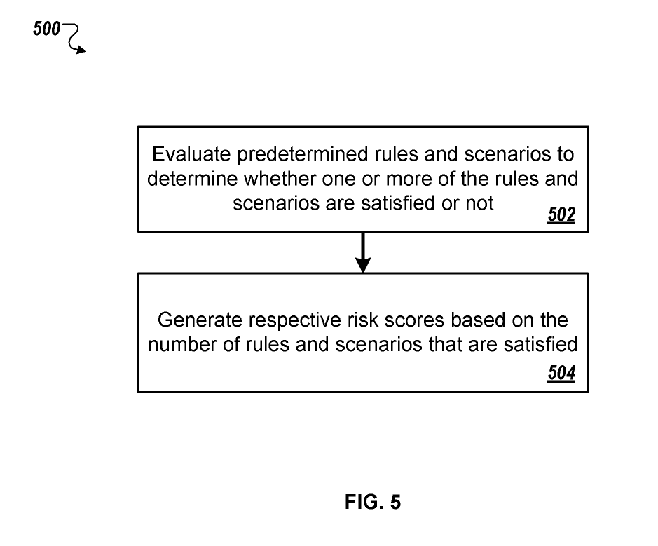

For example, the predetermined rules and scenarios may include static rule based scenarios, e.g., a rule corresponding to a scenario wherein an invoice amount exceeds the purchase order amount. As another example, the predetermine rules and scenarios may include paired rule based scenarios, e.g., a rule corresponding to a scenario linked to change request to critical fields and immediate payment. As another example, the predetermined rules and scenarios may include statistical rule based scenarios, e.g., a rule corresponding to abnormally high payments. As another example, the predetermined rules and scenarios may include network analysis based scenarios, e.g., a rule corresponding to procurement processes that are linked together via attributes such as cycling approver and requestor. An example process for generating risk scores for procurement processes using one or more predetermined rules and scenarios is described below with reference to FIG. 5.

The atypical patterns used by the system to generate risk scores for procurement processes include patterns in data that have been mined from historical input data using unsupervised learning techniques. One example atypical pattern includes atypically high payments, e.g., payments made to a vendor in return for goods or services that are above an average amount previously paid to the vendor, or payments made to a vendor in return for goods or services that are above an average amount previously paid for said goods or services.

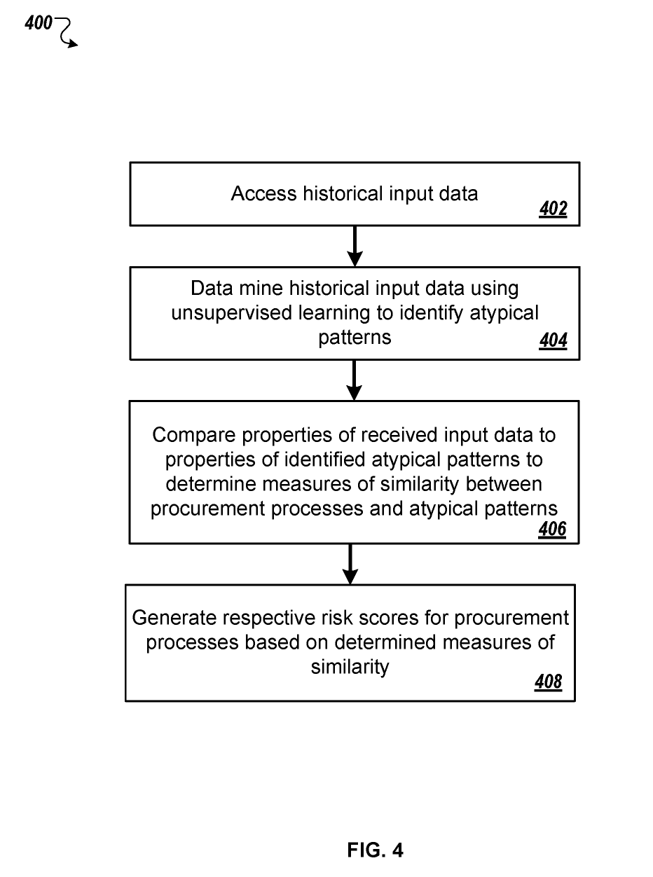

Another example atypical pattern includes atypical purchase patterns, e.g., patterns indicating repeated purchases, purchases of goods from a new, unknown vendor, purchases of goods from a vendor who normally provides different goods or services. Another example atypical pattern includes numerous atypical associations in purchases, e.g., procurement processes for which a General Ledger category is infrequent or atypical within the type of requestor role. Another example atypical pattern includes repeated procurement process by-pass, e.g., a pattern indicating that particular stages of various procurement processes are regularly proceeding without being approved or checked by an appropriate employee. Another example atypical pattern includes network patterns of various indications of fraudulent activity, e.g., procurement processes that are flagged as abnormally high payment and are linked together via attributes such as cycling approver and requestor. An example process for generating risk scores for procurement processes using atypical patterns data mined through unsupervised learning mechanisms is described below with reference to FIG. 4.

The system provides, based on the generated risk scores, output data representing procurement processes that are likely to be fraudulent (step 306). In some implementations provided output data may include data specifying one or more procurement processes, i.e., the system may flag a process as indicating fraudulent behavior. For example, the system may provide output data representing k top scoring procurement processes. In other implementations the system may provide procurement processes whose respective risk scores exceed a predetermined threshold.

In other implementations the system may provide more detailed output data. For example, the system may provide output data specifying one or more invoice line items of one or more procurement processes, i.e., the system may flag particular stages or actions within a procurement process as indicating fraudulent behavior. For example, the system may provide output data representing k top scoring invoice line items for a particular procurement process or for multiple procurement processes. In other implementations the system may provide output data representing invoice line items for a particular procurement process or for multiple procurement processes whose respective risk scores exceed a predetermined threshold.

In some implementations the system may receive feedback data confirming whether the output data indicating procurement processes that are likely to be fraudulent were in fact fraudulent or not. For example, a user of the system may review the output data and provide feedback data confirming whether the output data was accurate in indicating one or more procurement processes as likely being fraudulent.

Alternatively or in addition, the system may provide a user interface as output, where the user interface presents an aggregated view of information relating to the procurement processes that are likely to be fraudulent. User interface outputs are described in more detail above with reference to FIG. 2. In these implementations, the system may receive feedback data indicating whether the procurement processes that are likely to be fraudulent actually are fraudulent or not through the user interface.

The system may use received feedback data to update the one or more predetermined rules and scenarios described above with reference to step 304. For example, the system may provide output data indicating that a particular invoice line item of an invoice for a procurement process indicates fraudulent behavior, e.g., because the invoice line item includes a purchase of goods that exceeds a predetermined maximum quantity. In this example, in response to receiving feedback data indicating that the invoice line item is not indicative of fraudulent behavior, the system may update the maximum quantity in a corresponding rule to equal the amount in the invoice line item, i.e., update the rule to include a new predetermined maximum quantity. Generally, updates to rules and scenarios may be derived based on observed statistical patterns or trends in the feedback data.

FIG. 4 is a flow chart of an example process 400 for generating risk scores for procurement processes using atypical patterns data mined through unsupervised learning mechanisms. For convenience, the process 400 will be described as being performed by a system of one or more computers located in one or more locations. For example, a procurement fraud detection system, e.g., the system 200 of FIG. 2, appropriately programmed, can perform the process. Although the flowchart depicts the various stages of the process 400 occurring in a particular order, certain stages may in some implementations be performed in parallel or in a different order than what is depicted in the example process 400 of FIG. 4.

The system accesses historical input data (step 402). The historical input data may include previously received input data representing multiple procurement processes, as described above with reference to step 302 of FIG. 3.

The system mines the historical input data using unsupervised learning techniques to identify atypical patterns in the historical input data (step 404). For example, the system may apply anomaly detection techniques to identify items, events or observations that do not conform to an expected pattern or other items in the historical input data. As another example, the system may compare properties, e.g., type of categories of purchase orders and the frequent association with requester/approver/vendor, of the received input data to check the conformance or non-conformance to the previously identified atypical patterns in the historical input data to determine a measure of similarity/dissimilarity between the received input data and the identified atypical patterns. Example anomaly detection techniques that may be used by the system are described above with reference to FIG. 2. Example atypical patterns that may be identified in historical input data are described above with reference to step 304 of FIG. 3.

The system generates a respective risk score for each procurement process based on the determined measure of similarity (step 408). The assigned risk score may reflect the determined measures of similarity. For example, a procurement process that is determined to be similar to an atypical pattern in historical input data, e.g., a procurement process whose measure of similarity to an atypical pattern exceeds a predetermined threshold, may be assigned a higher risk score than a procurement process that is not determined to be similar to any atypical patterns in historical input data.

FIG. 5 is a flow chart of an example process 500 for generating risk scores for procurement processes using one or more predetermined rules and scenarios. For convenience, the process 500 will be described as being performed by a system of one or more computers located in one or more locations. For example, a procurement fraud detection system, e.g., the system 200 of FIG. 2, appropriately programmed, can perform the process. Although the flowchart depicts the various stages of the process 500 occurring in a particular order, certain stages may in some implementations be performed in parallel or in a different order than what is depicted in the example process 500 of FIG. 5.

The system evaluates the predetermined rules and scenarios to determine whether one or more of the predetermined rules and scenarios are satisfied or not (step 502). For example, the predetermined rules and scenarios may include rules that take the form of an {IF: THEN} expression, e.g., {IF “condition” THEN “result”} or {IF “condition 1” AND “condition 2” THEN “result”} where condition represents a complex matching or a similarity. The conditions may include predetermined indications of fraudulent activity, e.g., payments that exceed an approved maximum limits that learnt from unsupervised learning methods or abnormally and high frequency in requestor-vendors-approver relationships that learnt using network analysis etc. The results may include a vector of flags where each vector element represents particular rule evaluation result and results could possibly include a severity figure representing level of violation with respect to a specific rule.

The system generates a respective risk score for each procurement process based on whether the rules and scenarios are satisfied or not (step 504). For example, if the condition of a rule is satisfied, the system may then allocate an appropriate number of “points” to a risk score for the procurement process, e.g., {IF “condition” THEN “allocate 3 points to risk score.” In this manner, if an invoice line item satisfied 3 different rules, the invoice line item would be allocated a number of points corresponding to each rule.

FIG. 6 illustrates a schematic diagram of an exemplary generic computer system 600. The system 600 can be used for the operations described in association with the processes 300-500 described above according to some implementations. The system 600 is intended to represent various forms of digital computers, such as laptops, desktops, workstations, personal digital assistants, servers, blade servers, mainframes, mobile devices and other appropriate computers. The components shown here, their connections and relationships, and their functions, are exemplary only, and do not limit implementations of the inventions described and/or claimed in this document.

The system 600 includes a processor 610, a memory 620, a storage device 630, and an input/output device 640. Each of the components 610, 620, 630, and 620 are interconnected using a system bus 650. The processor 610 may be enabled for processing instructions for execution within the system 600. In one implementation, the processor 610 is a single-threaded processor. In another implementation, the processor 610 is a multi-threaded processor. The processor 610 may be enabled for processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 may be enabled for providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Thus, particular embodiments have been described. Other embodiments are within the scope of the following claims. For example, the actions recited in the claims may be performed in a different order and still achieve desirable results.

What is claimed is:

1. A computer implemented method for detecting procurement fraud in one or more procurement processes, the method comprising:
receiving input data representing one or more procurement processes;
processing the received input data to generate a respective risk score for each procurement process, each risk score representing a likelihood that the respective procurement process is fraudulent, comprising processing the received input data using
(i) one or more predetermined rules and scenarios, and
(ii) atypical patterns data mined through unsupervised learning mechanisms, wherein atypical patterns comprise one or more of atypically high payments, atypical purchase patterns, numerous atypical associations in purchases, repeated procurement process by-pass, or network patterns of various indications of fraudulent activity,
wherein processing the received input data to generate a respective risk score for each procurement process using atypical patterns data mined through unsupervised learning mechanisms comprises:
accessing historical input data;
data mining the historical input data using anomaly detection techniques to identify atypical patterns in the historical input data;
comparing properties of the received input data to properties of the identified atypical patterns in the historical input data to determine respective measures of similarity between the one or more procurement processes and the identified atypical patterns; and
generating a respective risk score for each procurement process based on the determined measure of similarity; and
providing, based on the generated risk score, output data indicating procurement processes that are likely to be fraudulent.

2. (canceled)

3. (canceled)

4. The method of claim 1, wherein the predetermined rules and scenarios comprise (i) static rule based scenarios, (ii) paired rule based scenarios, (iii) statistical rule based scenarios, or (iv) network analysis based scenarios.

5. The method of claim 4, wherein processing the received input data to generate a respective risk score for each procurement process using one or more predetermined rules and scenarios comprises:
evaluating the predetermined rules and scenarios to determine whether one or more of the predetermine rules and scenarios are satisfied or not; and
generating a respective risk score for each procurement process based on whether the rules and scenarios are satisfied or not.

6. The method of claim 1, wherein the received input data representing multiple procurement processes comprises procurement data for each procurement process, wherein procurement data comprises data representing (i) invoice line items, (ii) goods receipts, (iii) purchase order data, (iv) human resources data, or (v) vendor data associated with a procurement process in the organization.

7. The method of claim 6, wherein the received input data representing multiple procurement processes further comprises employee data for employees involved in the multiple procurement processes, wherein employee data comprises human resources data and data from external sources such as social media networks or professional networks.

8. The method of claim 6, wherein the received input data representing multiple procurement processes further comprises audit data.

9. The method of claim 6, wherein providing output data indicating procurement processes that are likely to be fraudulent comprises providing a number of top scoring invoice line items.

10. The method of claim 6, wherein providing output data indicating procurement processes that are likely to be fraudulent comprises providing invoice line items whose respective risk scores exceed a predetermined threshold.

11. The method of claim 1, further comprising receiving feedback data confirming whether the procurement processes that are likely to be fraudulent are fraudulent or not.

12. The method of claim 11, further comprising performing supervised learning using the received feedback data to update the one or more predetermined rules and scenarios.

13. The method of claim 11, wherein providing output data indicating procurement processes that are likely to be fraudulent comprises providing a user interface as output, the user interface presenting an aggregated view of information relating to the procurement processes that are likely to be fraudulent, and wherein feedback data is received through the user interface.

14. The method of claim 13, wherein the user interface presents a stratified representation of information relating to the procurement processes that are likely to be fraudulent.

15. The method of claim 13, wherein the user interface presents a linked data representation of information relating to the procurement processes that are likely to be fraudulent.

16. A system comprising:
one or more computers; and
one or more computer-readable media coupled to the one or more computers having instructions stored thereon which, when executed by the one or more computers, cause the one or more computers to perform operations comprising:
receiving input data representing one or more procurement processes;
processing the received input data to generate a respective risk score for each procurement process, each risk score representing a likelihood that the respective procurement process is fraudulent, comprising processing the received input data using
(i) one or more predetermined rules and scenarios, and
(ii) atypical patterns data mined through unsupervised learning mechanisms, wherein atypical patterns comprise one or more of atypically high payments, atypical purchase patterns, numerous atypical associations in purchases, repeated procurement process by-pass, or network patterns of various indications of fraudulent activity,
wherein processing the received input data to generate a respective risk score for each procurement process using atypical patterns data mined through unsupervised learning mechanisms comprises:
accessing historical input data;
data mining the historical input data using anomaly detection techniques to identify atypical patterns in the historical input data;
comparing properties of the received input data to properties of the identified atypical patterns in the historical input data to determine respective measures of similarity between the one or more procurement processes and the identified atypical patterns; and
generating a respective risk score for each procurement process based on the determined measure of similarity; and
providing, based on the generated risk score, output data indicating procurement processes that are likely to be fraudulent.

17. (canceled)

18. (canceled)

19. The system of claim 16, wherein the predetermined rules and scenarios comprise (i) static rule based scenarios, (ii) paired rule based scenarios, (iii) statistical rule based scenarios, or (iv) network analysis based scenarios.

20. One or more non-transitory computer-readable media having instructions stored thereon that, when executed by one or more processors, cause performance of operations comprising:
receiving input data representing one or more procurement processes;
processing the received input data to generate a respective risk score for each procurement process, each risk score representing a likelihood that the respective procurement process is fraudulent, comprising processing the received input data using
(i) one or more predetermined rules and scenarios, and
(ii) atypical patterns data mined through unsupervised learning mechanisms, wherein atypical patterns comprise one or more of atypically high payments, atypical purchase patterns, numerous atypical associations in purchases, repeated procurement process by-pass, or network patterns of various indications of fraudulent activity,
wherein processing the received input data to generate a respective risk score for each procurement process using atypical patterns data mined through unsupervised learning mechanisms comprises:
accessing historical input data;
data mining the historical input data using anomaly detection techniques to identify atypical patterns in the historical input data;
comparing properties of the received input data to properties of the identified atypical patterns in the historical input data to determine respective measures of similarity between the one or more procurement processes and the identified atypical patterns; and
generating a respective risk score for each procurement process based on the determined measure of similarity; and
providing, based on the generated risk score, output data indicating procurement processes that are likely to be fraudulent.
